(19) United States
(12) Patent Application Publication
(10) Pub. No.: US 2019/0195096 A1
(43) Pub. Date: Jun. 27, 2019

(54) Piston for a reciprocating-piston internal combustion engine

(71) Applicant: MAN Truck & Bus AG, Munchen (DE)

(72) Inventors: Thomas Malischewski, Heilsbronn (DE); Jens Dietrich, Heilsbronn (DE); Jürgen Ritter, Nürnberg (DE); Dominik Renner, Ansbach (DE)

(21) Appl. No.: 16/223,915

(22) Filed: Dec. 18, 2018

(30) Foreign Application Priority Data
Dec. 21, 2017 (DE) 102017130962.4

(51) Int. Cl. F01M 11/02; F02F 3/22; F02F 3/28; F01P 3/10

(52) U.S. Cl. CPC F01M 11/02; F02F 3/22; F01M 2011/027; F01P 3/10; F02F 3/28

(57) ABSTRACT

A piston for a reciprocating-piston internal combustion engine includes a piston head and a piston skirt. The piston head has an encircling ring zone having at least one ring groove for a piston ring and an encircling cooling duct. In this case, the piston further includes at least one first bore starting from the cooling duct, the bore leading from the cooling duct to a bearing location of an upper connecting-rod bearing pin of the piston and opening into the bearing location in the form of a bore opening in order to supply the piston pin with lubricant from the cooling duct.

The invention relates to a piston for a reciprocating-piston internal combustion engine.

Pistons for a reciprocating-piston internal combustion engine are known from the prior art, e.g. from German Laid-Open Application DE 10 2014 010 106 A1. A piston of this kind is generally arranged in a cylinder of a reciprocating-piston internal combustion engine. The piston has a piston skirt, which is also commonly referred to as the “body” or “piston body”. The German term for “piston skirt” is “Kolbenhemd”. Moreover, the piston has a ring zone which adjoins the piston skirt in the axial direction of the piston and has at least one ring groove for a piston ring. The ring zone is part of the piston head.

In the case of pistons that are known in practice, the piston is supplied with lubricating oil by spraying it with lubricant from below by means of an oil spray nozzle. In this case, the piston pin is lubricated only passively from the outside by oil mist. DE 10 2011 012 686 A1 discloses a piston having a piston head and a piston body, wherein the piston head has an encircling ring zone and, in the region of the ring zone, an encircling cooling duct, and the piston body has bearing surfaces associated respectively with its pressure side and its counter pressure side. In this case, a bore which starts from the cooling duct is provided, which opens in the form of a bore opening into the bearing surface associated with the counter pressure side and is arranged on a slope, such that it encloses an acute angle with the central axis of the piston and that the bearing surface associated with the counter pressure side has a depression in the region of the at least one bore opening. It is thereby possible to improve the lubricating oil supply to the bearing surface of the piston but not to supply lubricating oil to the piston pin.

It is an object of the invention to provide an improved piston for a reciprocating-piston internal combustion engine, by means of which disadvantages of conventional pistons can be avoided. In particular, it is the object of the invention to provide a piston for a reciprocating-piston internal combustion engine by means of which an improved lubricating oil supply is made possible.

These objects are achieved by a piston for a reciprocating-piston internal combustion engine that has the features of the independent claim. Advantageous embodiments and uses of the invention form the subject matter of the dependent claims and are explained in greater detail in the following description, in some cases with reference to the figures.

According to general aspects of the invention, a piston for a reciprocating-piston internal combustion engine is provided, said piston being guided in a sliding manner in a cylinder liner of a cylinder of the internal combustion engine and comprising, in a manner known per se, a piston head and a piston skirt. The piston skirt serves to guide the piston in the cylinder liner. The piston skirt adjoins the ring zone in the axial direction of the piston. In this case, the axial direction corresponds to the direction of movement of the piston in the cylinder. It has already been stated above that the piston skirt is also referred to as the piston body.

The piston head is also referred to as the piston top. The piston head comprises an encircling ring zone having at least one annular groove for a piston ring and an encircling cooling duct. The cooling duct is preferably arranged at the level of the ring zone. The first cooling duct is embodied to carry the flow of a medium, in particular a lubricant, e.g. oil. For this purpose, the cooling duct has a feed opening, via which lubricant can enter the cooling duct, and a drain opening, via which the lubricant can drain out of the cooling duct. The cooling duct can be used to cool the combustion chamber recess, which is also referred to as the piston recess. In this arrangement, the combustion chamber recess heated by the combustion process heats the medium, e.g. the lubricant.

According to the invention, at least one first bore starting from the cooling duct is provided, said bore leading from the cooling duct to a bearing location of an upper connecting-rod bearing pin of the piston and opening into the bearing location in the form of a bore opening. This bore is referred to below as the “first bore” in order to distinguish it from another bore, which is referred to as the second bore and which will be described below. The at least one first bore is used to supply the piston pin with lubricant from the cooling duct, i.e. the piston is embodied in such a way that lubricant can be fed directly to the bearing location of the upper connecting-rod pin of the piston from the first cooling duct via the first bore, i.e. the first cooling duct ends immediately or directly in the bearing location of the upper connecting-rod bearing pin. Via the first bore in combination with the cooling duct, it is possible to provide an active supply of lubricant to the upper connecting-rod bearing pin in order to significantly improve the wear resistance of the piston, in particular of the connecting-rod bearing pin.

An embodiment of the first bore is particularly advantageous in which said bore starts from a lower side of the cooling duct, thereby ensuring a good supply of lubricant to the first bore from the cooling duct during the reciprocating motion of the piston. According to one embodiment, the at least one first bore extends in the axial direction of the piston.

In the context of the invention, there is the possibility of providing only one first bore. As an alternative, it is also possible to provide a plurality of first bores in order to increase the lubricant supply to the upper piston pin from the cooling duct of the piston head.

According to another preferred embodiment, the lubricant supply can be improved by providing at least one additional bore, referred to below as the second bore, starting from the cooling duct, which bore, starting from a cooling duct lower side, opens in the form of an outflow bore opening into a bearing surface of the piston, wherein the outflow bore opening opens into the bearing surface below an oil scraper ring of the ring zone. The oil scraper ring is the lowest ring of the ring zone. However, the provision of the at least one second bore is optional.

It is thereby possible to achieve an active lubricant supply to the bearing surface of the piston via the cooling duct. It is particularly advantageous here if the outflow bore opening of the second bore opens into the bearing surface immediately below the oil scraper ring of the ring zone.

There is furthermore the possibility of providing a plurality of second bores, which are arranged in a manner distributed over a width of the bearing surface. In other words, a plurality of second bores is provided radially in the region of the piston head in order to allow a thicker lubricating film for the piston skirt. It is thereby possible to perform fine tuning of the oil film in the radial direction (which is perpendicular to the axial direction of the piston) in order to optimize the friction power of the engine.

According to another aspect, the lower side of the cooling duct can be arranged above the outflow bore opening of the second bores in the axial direction of the piston, with the result that the at least one second cooling duct is arranged on a slope, and therefore lubricant entering the second bore from the cooling duct is carried obliquely downwards to the outflow bore opening. Here, “downwards” means away from the piston head in the direction of the crankshaft connecting rod or in the direction of the piston pin.

A motor vehicle having a piston as described in this document is furthermore provided. The motor vehicle can be a commercial vehicle, e.g. a heavy goods vehicle or a bus.

The preferred embodiments described above and the features of the invention can be combined with one another in any desired manner. It is emphasized that the piston can also be provided only with the at least one second bore, that is to say without the at least one first bore, and vice versa. Further details and advantages of the invention are described below with reference to the attached drawings, in which:

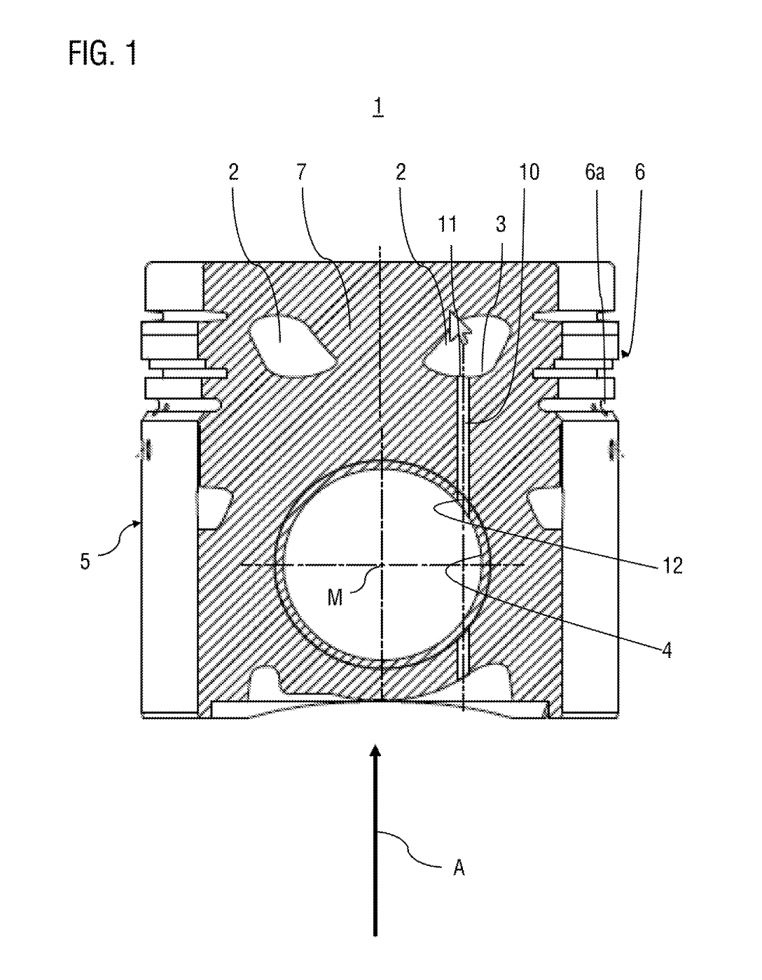

FIG. 1 shows a partial section of a piston according to a first embodiment;

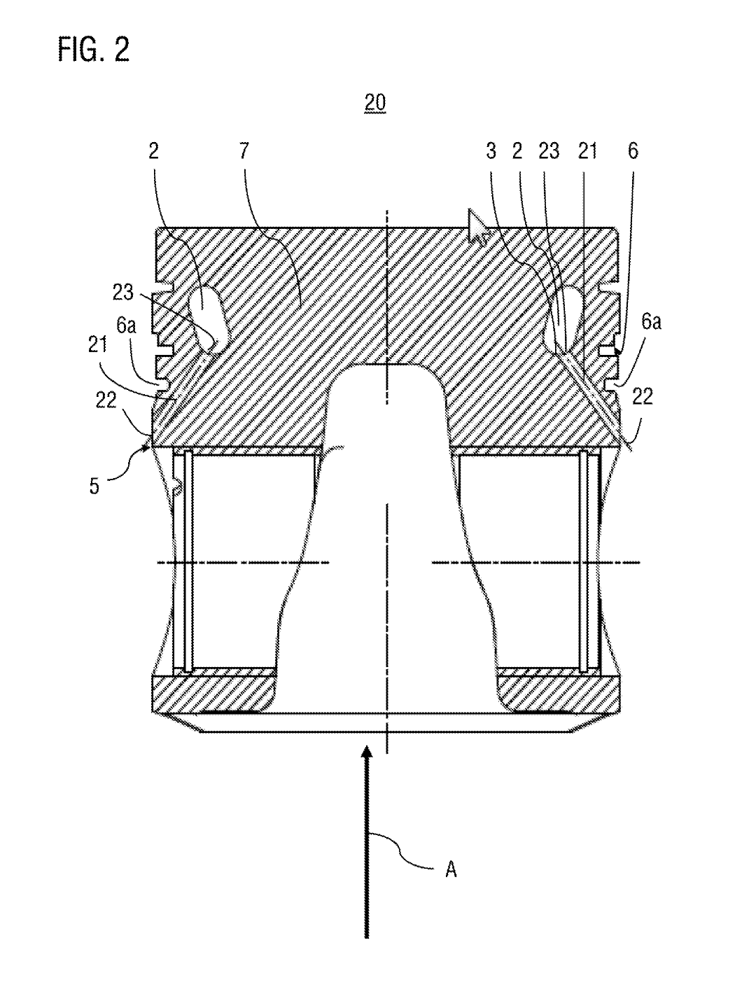

FIG. 2 shows a cross section of a piston according to a second embodiment; and

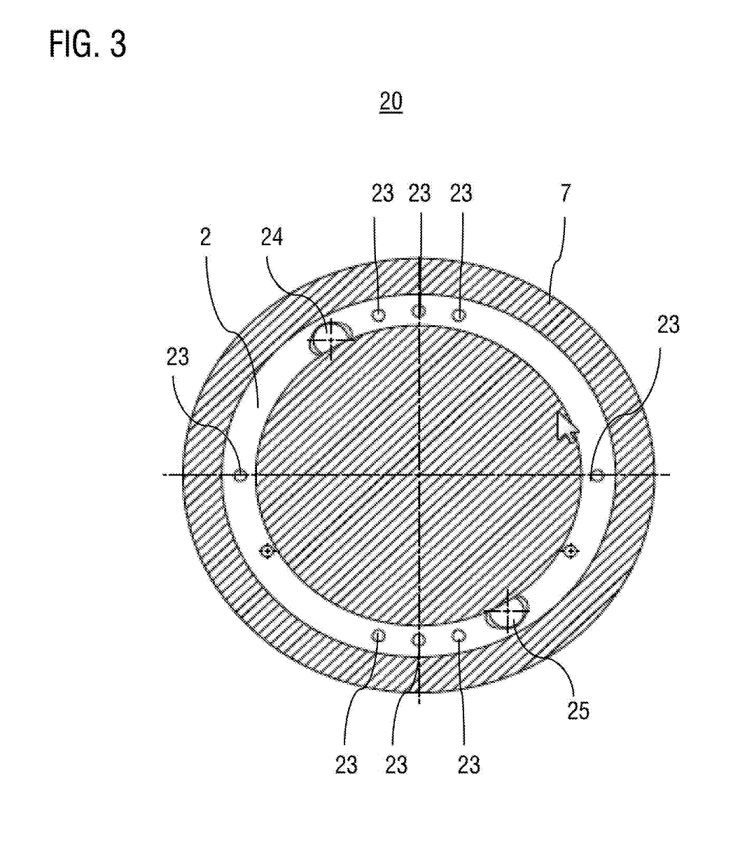

FIG. 3 shows a plan view of the piston in section according to the second embodiment.

In all the figures, identical or functionally equivalent elements are denoted by the same reference signs and are not described separately in all cases.

FIG. 1 shows a partial section of a first embodiment of the invention. The piston 1 comprises a piston head 7, which has an encircling ring zone 6. The ring zone 6 comprises a plurality of ring grooves for the reception of piston rings (not illustrated). Reference sign 6a denotes the ring groove for the oil scraper ring (not illustrated). Adjoining the ring zone 6 towards the bottom in the axial direction A is the piston skirt 5, which, in contrast to the ring zone 6, can be embodied in such a way that it does not form a complete circle. The piston skirt 1 is provided with sliding support in the cylinder liner of the cylinder, wherein a wall of the piston skirt slides backwards and forwards along the cylinder liner as the piston moves. The piston 11 is mounted in a corresponding cylinder (not illustrated) of a cylinder piston housing (not illustrated) of a reciprocating-piston internal combustion engine. In this case, the piston skirt 1 has at least one piston-pin hole 4 as a bearing location for accommodating the upper connecting-rod pin (not illustrated). A connecting rod (not illustrated) mounted on the crankshaft is connected in an articulated manner to the piston 1 by means of a connecting-rod bearing pin of this kind in order, by virtue of this articulated coupling, to convert the translational movements of the piston 1 in the cylinder into rotary movements of the crankshaft around the axis of rotation of the latter.

The piston 1 furthermore comprises a cooling duct 2, which is arranged in the piston head 7 at the level of the ring zone 6.

The piston 1 furthermore has at least one first bore 10 starting from the cooling duct 2, said bore leading from the cooling duct 2 to a bearing location 4 of the upper connecting-rod bearing pin of the piston and opening into the bearing location 4 in the form of a bore opening 12. This first bore 10 is used to supply the piston pin with lubricant from the cooling duct 2. The first bore extends downwards, parallel to the axial direction A, and starts from the lower side 3 of the cooling duct 2 and opens directly into the bearing location 4 of the upper connecting-rod bearing pin.

During the accelerated upward movement and the decelerating downward movement of the piston, the oil lies on the lower side 3 of the cooling duct and, during the decelerating upward movement and the accelerated downward movement of the piston rests on the upper side of the cooling duct 2. During the accelerated upward movement and the decelerating downward movement of the piston, lubricant is thus forced out of the cooling duct into the first bores 10 and re-emerges through the outlet opening 12 to provide an active supply of lubricating oil to the upper connecting-rod bearing pin. In this way, active lubrication can be ensured by means of the cooling duct 2 of the upper piston-rod bearing pin (piston pin) in order significantly to improve wear resistance in comparison with passive lubrication by oil mist from the outside.

FIGS. 2 and 3 illustrate a second embodiment example of a piston 20, in which one or more second bores 21 are provided, which are provided as an alternative or preferably in addition to the first bore 10.

The at least one second bore 21 likewise starts from a lower side 3 of the cooling duct 2 and opens in the form of an outflow bore opening 22 into a bearing surface of the piston 20, wherein the outflow bore opening 22 opens into the bearing surface immediately below a ring groove 6a for the reception of the oil scraper ring of the ring zone 6. A depression can be provided in the region of the outflow bore opening 22. However, it is also possible for no depression to be provided.

In the case of contemporary internal combustion engines with pistons that do not have a second bore 21 of this kind, the lubricating film on the cylinder liner is set by the oil scraper ring and, in part, by the taper face ring. The cylinder liner is wetted with oil as far as the region where the piston skirt ends at top dead centre. Some of the oil for wetting the cylinder liner is oil from the connecting-rod bearings owing to the centrifugal effect and some is oil from the oil spray nozzle which does not land in the cooling duct 2.

The region which oil does not actively enter amounts to about 50% of the piston path. The piston rings must transport the oil for lubrication to this region during the upward movement. The matching of the piston rings is extremely important in this process in order to ensure that the amount of oil distributed over the cylinder liner is not too great or too small.

According to the second embodiment example, the upper region of the cylinder liner can also be actively wetted with oil by introducing into the piston 20 the bores 21, which extend from the lower side 4 of the piston cooling duct to the outside just below the oil scraper ring or the ring groove 6a thereof. This makes it possible to design the ring package in a different way to save friction power and minimize the oil consumption of the engine.

The provision of the second bores 21 ensures that, during the accelerated upward movement of the piston and the decelerating downward movement of the piston, a trace of oil is deposited on the cylinder liner, this being distributed radially by the oil scraper ring during the downward movement. The actively wetted region is thus maximized. During the accelerated upward movement and the decelerating downward movement of the piston, the oil lies on the lower side 3 of the cooling duct and, during the decelerating upward movement and the accelerated downward movement of the piston rests on the upper side of the cooling duct 2. During the accelerated upward movement and the decelerating downward movement of the piston, lubricant is thus forced out of the cooling duct into the second bores 21 and re-emerges through the outflow bore opening 22 to provide an active supply of lubricating oil to the upper region of the cylinder liner.

Another positive effect of the forced lubrication from the cooling duct is the fact that this engine oil has a higher temperature than the sprayed oil. Thus, the viscosity is lower and hence reduces the piston body friction even further.

As can be seen in the plan view of the piston in FIG. 3, a plurality of second bores is provided, which are expediently arranged in a manner distributed over a width of the bearing surface. In FIG. 3, the corresponding inlet openings 23 of the second bores, via which lubricant can enter the second bores 21 from the cooling duct, can be seen. It is thereby possible to perform fine tuning of the oil film in the radial direction in order to optimize the friction power of the engine. The feed opening 24, via which lubricant can enter the cooling duct 2, and the drain opening 25, via which the lubricant can leave the cooling duct, are furthermore illustrated. The diameters of the feed opening 24 and of the drain opening 25 are larger than the diameters of the second bores 23.

Although the invention has been described with reference to particular embodiment examples, it is evident to a person skilled in the art that various changes can be made and equivalents used as replacements without exceeding the scope of the invention. In addition, many modifications can be made without exceeding the relevant scope. Thus, there is no intention to restrict the invention to the embodiment examples disclosed, the intention being, on the contrary, to include all embodiment examples which fall within the scope of the attached patent claims. In particular, the invention also claims protection for the subject matter and the features of the dependent claims independently of the claims to which they refer.

### LIST OF REFERENCE SIGNS

1 piston
2 cooling duct
3 lower side of the cooling duct
4 piston-pin hole, bearing location of the upper connecting-rod pin
5 piston skirt
6 ring zone
6a annular groove for oil scraper ring
7 piston head
10 first bore
11 bore opening, inlet opening
12 bore opening, outlet opening
20 piston
21 second bore
22 bore opening, outlet opening
23 bore opening, inlet opening
24 feed opening
25 drain opening
A axial direction

1. A piston for a reciprocating-piston internal combustion engine, comprising:
a piston head and a piston skirt, wherein the piston head has an encircling ring zone having at least one ring groove for a piston ring and an encircling cooling duct,
at least one first bore starting from the cooling duct, said bore leading from the cooling duct to a bearing location of an upper connecting-rod bearing pin of the piston and opening into the bearing location in the form of a bore opening in order to supply the piston pin with lubricant from the cooling duct.

2. The piston according to claim 1, wherein the at least one first bore starts from a lower side of the cooling duct.

3. The piston according to claim 2, wherein the at least one first bore extends in the axial direction (A) of the piston.

4. The piston according to claim 3, further comprising at least one second bore starting from the cooling duct, which, starting from a cooling duct lower side, opens in the form of an outflow bore opening into a bearing surface of the piston, wherein the outflow bore opening opens into the bearing surface below an oil scraper ring of the ring zone.

5. The piston according to claim 4, wherein the outflow bore opening opens into the bearing surface immediately below the oil scraper ring of the ring zone.

6. The piston according to claim 4, wherein the at least one second board comprises a plurality of second bores arranged in a manner distributed over a width of the bearing surface.

7. The piston according to one of the claim 4, wherein:
a) the cooling duct is arranged at the level of the ring zone; and/or
b) the lower side of the cooling duct is arranged above the outflow bore opening of the second bores in the axial direction (A) of the piston, with the result that the at least one second cooling duct is arranged on a slope.

8. The piston according to claim 1, wherein the at least one first bore extends in the axial direction (A) of the piston.

9. The piston according to claim 1, wherein that at least one first bore comprises a plurality of first bores.

10. The piston according to claim 1, wherein only a first bore is provided.

11. The piston according to claim 1, further comprising at least one second bore starting from the cooling duct, which, starting from a cooling duct lower side, opens in the form of an outflow bore opening into a bearing surface of the piston, wherein the outflow bore opening opens into the bearing surface below an oil scraper ring of the ring zone.

12. The piston according to claim 11, wherein the outflow bore opening opens into the bearing surface immediately below the oil scraper ring of the ring zone.

13. The piston according to claim 11, wherein the at least one second board comprises a plurality of second bores arranged in a manner distributed over a width of the bearing surface.

14. The piston according to one of the claim 11, wherein:
a) the cooling duct is arranged at the level of the ring zone; and/or
b) the lower side of the cooling duct is arranged above the outflow bore opening of the second bores in the axial direction (A) of the piston, with the result that the at least one second cooling duct is arranged on a slope.

15. A motor vehicle, in particular a commercial vehicle, having a piston, the piston comprising:
a piston head and a piston skirt, wherein the piston head has an encircling ring zone having at least one ring groove for a piston ring and an encircling cooling duct,
at least one first bore starting from the cooling duct, said bore leading from the cooling duct to a bearing location of an upper connecting-rod bearing pin of the piston and opening into the bearing location in the form of a bore opening in order to supply the piston pin with lubricant from the cooling duct.

16. The motor vehicle according to claim 15, wherein the piston further comprises at least one second bore starting from the cooling duct, which, starting from a cooling duct lower side, opens in the form of an outflow bore opening into a bearing surface of the piston, wherein the outflow bore opening opens into the bearing surface below an oil scraper ring of the ring zone.
